(19) United States
(12) Patent Application Publication
(10) Pub. No.: US 2011/0202668 A1
(43) Pub. Date: Aug. 18, 2011

(54) Methods for Creating and Using a Telecommunications Link between Two Users of a Telecommunications Network

(75) Inventors: Aline TARRAGO, Sceaux (FR); Laurent COMBET, Paris (FR); Roland MEYER, Nice (FR)

(73) Assignee: France Telecom, Paris (FR)

(21) Appl. No.: 13/028,159

(22) Filed: Feb. 15, 2011

(30) Foreign Application Priority Data
Feb. 15, 2010 (FR) 10/51057

(51) Int. Cl. G06F 15/16

(52) U.S. Cl. 709/228

(57) ABSTRACT

A technique is disclosed for the creation and the use of a telecommunications link between two users of a telecommunications network. Disclosed in particular is the technical creation of a social links network employing a telecommunications network. A method is disclosed for creating a telecommunications link between a first set of communications devices associated with a first user and a second set of communications devices associated with a second user, including generating a pair of certified identifiers of the first and second users allowing a communications session to be set up between at least a communications device of the first set and a communications device of the second set.

### RELATED APPLICATIONS

This application claims the priority of French patent application Ser. No. 10/51057 filed Feb. 15, 2010, the entire content of which is hereby incorporated by reference.

### FIELD OF THE INVENTION

The invention relates to the creation and the use of a telecommunications link between two users of a telecommunications network. The invention relates in particular to the technical creation of a network of social links employing a telecommunications network.

### BACKGROUND OF THE INVENTION

In the past, when users of a telecommunications network have wished to contact another user, they have used a communications terminal to set up a communications session with another communications terminal associated with the other user. Once the call was finished, users had no record of the remote communication between them. Also, no exchange of content between the two users was possible apart from voice exchange during this session.

The Internet has made it possible to preserve these links by setting up social networking sites. These sites enable users to register links between them, preserve them, and use them to interact with one another, notably via instant messaging, electronic mail, etc.

Social networking makes it possible to set up and store a link between an Internet user, as a function of the profile that they offer on the Internet, and one or more users, namely “my friends”, and one or more users already linked thereto, namely “friends of my friends”. Some social networking sites are moreover suffering from the load imposed by the exponential social graph resulting from these numerous links.

Users are thus engulfed in an exponential social graph no longer meeting all their requirements, in particular that of being able to interact more creatively within a restricted circle of users with universal mutual trust, guarded against exposure, and protected from intrusion. Moreover, the number of users involved in a discussion forum generally falls relatively quickly to a few active users, other users following the discussion from a great distance or even quickly losing interest in it.

On the Internet, because of anonymity and the dominant economic principle of funding by advertising, and therefore audience-seeking, the link is effected between virtual users, with the choice of contents made available on the network being motivated by suspicion about the use that will be made of those contents. Thus information circulating on social networking sites has a low degree of reliability and a user making contents available has no way of removing their contents when the use that is being made thereof is no longer what they would approve of.

### SUMMARY OF THE INVENTION

One of the objects of the present invention is to improve on the prior art.

One aspect of the invention is directed to a method of creating a telecommunications link between a first set of communications devices associated with a first user and a second set of communications devices associated with a second user, including generating a pair of certified identifiers of the first and second users allowing a communications session to be set up between at least a communications device of the first set and a communications device of the second set.

Thus the link created is certified, which makes it possible to link two users of the telecommunications network and not their projection in the network. Moreover, the link is between the two users alone, the information concerning its existence being accessible only for technical access control reasons; from this principle stems a limitation on the size of the social networking graph and thus, for the source user (the first user) improved control of what is exchanged.

Said telecommunications link creation method advantageously includes an invitation from a communications device of the first set having access to a certified identifier of the first user to a communications device of the second set having access to a certified identifier of the second user.

Thus the link is not one-to-one and is created only at the initiative of the source user, the first user.

Said telecommunications link creation method advantageously includes associating a time period with said link, said time period prohibiting a communications session being set up between at least a communications device of the first set and a communications device of the second set outside said time period.

Thus the user creating the link is able to schedule occasional encounters with specific, clearly-identified other parties.

In one implementation of the invention the steps of the method of the invention are advantageously executed by a computer program or software, the software comprising software instructions intended to be executed by a data processor of a communications device and being designed to command the execution of the steps of the method.

Another aspect of the invention provides a program comprising program code instructions for executing the steps of the telecommunications link creation method when said program is executed by a processor.

Also disclosed is a method of using a telecommunications link including setting up, from a pair of certified identifiers of a first user and a second user, a communications session between at least a communications device of a first set of communications devices associated with said first user and a communications device of a second set of communications devices associated with said second user.

Said link use method advantageously includes a transfer from the user first one to a third user, said transfer allowing transferring said communications session from a communication device of first set of communication devices associated with first user to at least a communication device of a third set of communication devices associated with third user.

Thus the first user may ask the third user to handle the link with the second user under many reasons, in particular: availability, such as the second user may exchange in the same context as expected with the first user: in particular, the third user is another member of the family, or in the case of professional link: a assistant or a colleague. This transfer may be:

global, for all the shared applications and\or the associated exchanges or not to these shared applications using this link,

specific to one or several shared applications and\or exchanges associated to these shared applications using this link.

Said link use method advantageously includes an association of an application to be shared (P) with said link of telecommunication.

Thus the application may be an excuse for exchanging between the first user and the second user of the link. In particular, around a leisure application such as an photo album the first user has associated with the link in sharing: the second user may thus consult the photo album and, using the link, the first user can join him on the photo album which he will see in the same context as the second user (i.e. if the second user goes to next photo, the first user will automatically see displaying the same photo) and\or to begin a textual, audio, or video communication with the second user: this communication using the link.

Said link use method advantageously includes a transfer from the first user to the third user, said transfer allowing transferring from the first user to the third user a sharing of an application to share associated said link of the first user with the second user.

Thus the first user may ask to a third user to handle the link with the second user for an application to share associated with the link for many reasons in particular of availability so that the second user may exchange in the same context as expected for the first user: in particular the third user is another member of the family, or in the case of professional link: a assistant or a co-worker for this application to be only shared.

Said link use method advantageously includes an on-demand suppression of a telecommunications link between a first user and a second user at the request of at least one communications device of a first set of communications devices associated with a first user and a second set of communications devices associated with a second user.

Thus each of the two parties retains control of the link by virtue of being able to decide to break the link at any time and unilaterally.

In one implementation of the invention, the steps of the method are advantageously executed by a computer program or software, the software comprising software instructions intended to be executed by a data processor of a device of a telecommunications network and being designed to command the execution of the steps of the method.

Another aspect of the invention provides a program comprising program code instructions for executing the steps of the method of using a telecommunications link when said program is executed by a processor.

These programs may use any programming language and take the form of source code, object code or a code intermediate between source code and object code, such as a partially-compiled form, or any other desirable form.

Another aspect of the invention provides one or more information media for one or more of the above programs.

An information medium may be any device or entity capable of storing the program. For example, the medium may include storage means, such as a read only memory (ROM), for example a compact disk (CD) ROM or a micro-electronic circuit ROM, or magnetic storage means, for example a floppy disk or a hard disk.

Also, the information medium may be a transmissible medium such as an electrical or optical signal, which may be routed via an electrical or optical cable, by radio or by other means. The program of the invention may in particular be downloaded over an Internet-type network.

Alternatively, the information medium may be an integrated circuit incorporating one of more of the programs, the circuit being adapted to execute the method in question or to be used in its execution.

Another implementation of the invention uses software and/or hardware components. Thus the term “module” may refer either to a software component or to a hardware component. A software component consists of one or more computer programs, one or more subroutines of a program, or more generally any element of a program or software allowing a function or a set of functions as described below to be implemented. A hardware component is any element of a hardware system allowing a function or a set of functions to be implemented.

Another aspect of the invention provides a telecommunications link including a pair of certified identifiers of first and second users allowing a communications session to be set up between at least a communications device of a first set of communications devices associated with said first user and a communications device of a second set of communications devices associated with said second user.

Another aspect of the invention provides a telecommunications network device including means for generating a pair of certified identifiers of a first user and second user allowing a communications session to be set up between at least a communications device of a first set of communications devices associated with said first user and a communications device of a second set of communications devices associated with said second user.

The telecommunications network device advantageously includes means for setting up, from a pair of certified identifiers of a first user and a second user, a communications session between said communications device of said first user and a communications device of said second set.

Another aspect of the invention provides a device for managing a relational service between users including the telecommunications network device.

Thus, it is a service provider that is responsible for managing the links, making a more secure connection possible because neither party has access to the pair of certified identifiers.

The service management device advantageously includes means for storing contents associated with a first user of said telecommunications link, the storage means allowing a communications device of the second user to access said content associated with said first user of said telecommunications link during a telecommunications session set up using said link.

Thus, the link created makes it possible for a source user (the first user) to share contents, retaining control thereof. This makes it possible for the provider of such a content-sharing service based on the telecommunications link created in this way to make the source user in the context of content sharing responsible for the content that they make available. The placement of these contents in the contents storage means of the service management device, whether or not co-located with the means for generating pairs of certified identifiers and the communications session set-up means, makes it possible for users sharing their contents to have access to a storage space the size of which is optionally modifiable as a function of their requirements and to make their communications devices secure by not giving third parties access to them. In particular, the content is accessible in all the forms necessary to the communications device used by the link, where appropriate the communications device declared by the one that received the link.

Another aspect of the invention provides a communications device of a first user including the telecommunications network device, wherein the certified identifier of the first user is provided by said communications device.

The communications device advantageously includes means for inviting a communications device having access to a certified identifier of the second set of the second user allowing generation means to be triggered using the response of the communications device of the second set.

A communications device of a first set of communications devices associated with a first user including the communications device described above advantageously includes means for storing contents associated with said telecommunications link allowing a communications device of the second user to access said content associated with said telecommunications link during a telecommunications session set up using said link.

Thus the link created makes it possible for a source user (the first user) to share contents, retaining control thereof. This makes it possible in the context of content sharing for the provider of such a content-sharing service based on the telecommunications link created in this way to make the source user responsible for the content that they make available. Furthermore, a content sharing space may consist of one or more of these storage means, which may be located in any communications device, or even in more than one communications device, of the first user sharing their contents. At least one of these communications devices may consist of means associated with the first user located in the telecommunications network, for example on a server of a telecommunications carrier or a service provider.

### BRIEF DESCRIPTION OF THE DRAWINGS

FIG. 1 is a simplified diagram of an embodiment of a method of the invention for creating a telecommunications link;

FIG. 2 is a detailed diagram of a variant of a method of the invention for creating a telecommunications link;

FIG. 3 is a simplified diagram of an embodiment of a method of the invention for using a telecommunications link; and

FIGS. 4a and 4b are simplified diagrams of telecommunications network architectures enabling telecommunications link creation and use in accordance with an embodiment of the invention in a service management device and in a communications device of a first user, respectively.

### DETAILED DESCRIPTION OF EMBODIMENTS OF THE INVENTION

The variants of the invention described below may be implemented individually or in combination.

The invention provides a telecommunications link that is special in that it uses a pair of certified identifiers of two users, a first user and a second user. This telecommunications link allows a communications session to be set up between at least a communications device of a first set of communications devices associated with said first user and a communications device of a second set of communications devices associated with said second user.

By identifier is meant any type of data directly or indirectly identifying the user of a communications device in a telecommunications network. By direct identifier is meant an identifier of the user and not of the communications device, such as a name or a biometric imprint (fingerprint, palm print, iris print, etc.), and by indirect identifier is meant a serial number, a subscriber identity module (SIM)-type identifier, etc. of the communications device associated with a user.

By certified identifier is meant an identifier such that only the user associated with that identifier either directly or via their communications device may use the identifier because verification of the identity of the user is within the remit of the communications device (such as a mobile telephone with a SIM card) and because the associated identifier is secure or by appointing a trusted third party to manage certified identifiers.

The communications devices include communications terminals such as a mobile telephone, a landline telephone, a computer whether or not connected to the network via an asymmetric digital subscriber liner (ADSL) connection, in particular an Ethernet cable, or via a WiFi or Bluetooth wireless connection or via a cellular (for example 3G) network, a television connected to the Internet directly or via a set-top box, a communicating object (such as a health- or leisure-oriented communicating object or other contactless peripheral), a hub (home automation), etc. Furthermore, the communications devices may consist of means provided in the network and associated with the user, in particular making possible sharing of contents (in the wide sense, i.e. contents or applications).

The invention thus lies in the technical context of authentication, notably by means of SIM cards, and the convergence of terminals using communities of terminals of a user.

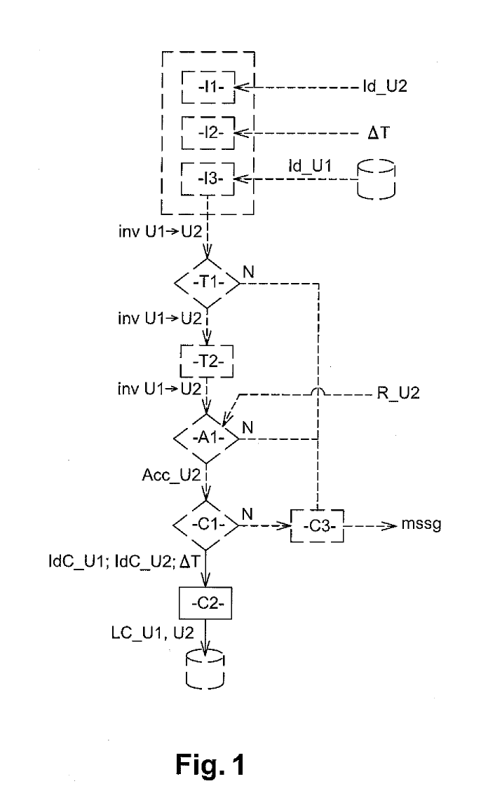

FIG. 1 is a simplified diagram of a method of the invention of creating a telecommunications link. The creation of a telecommunications link between:
a first user U1 represented by a set (a first set) of communications devices that are associated with the user; and
a second user also represented by a set (a second set) of communications devices that are associated with the user;
   includes generating C2 a pair of certified identifiers of the first and second users (IdC_U1, IdC_U2) allowing a communications session to be set up between at least a communications device of the first set and a communications device of the second set.

In one particular application, the first user U1 indicates I1 the second user U2 to whom they wish to set up a link. To this end, they select the second user U2 in their address book, making it possible to associate an identifier Id_U2 of this second user U2 with an invitation inv U1→U2. The invitation inv U1→U2 is generated using this indication. In one particular embodiment, the identifier Id_U2 of the second user is a certified identifier.

In one particular embodiment, when creating telecommunications link the first user is offered the possibility of limiting it in time. Generating the invitation inv U1→U2 includes associating a time period ΔT with said link. This time period is in particular indicated I2 by the first user U1 or extracted from a diary. Said time period prohibits setting up a communications session between at least a communications device of the first set and a communications device of the second set outside said time period.

In one particular embodiment, generating the invitation inv U1→U2 includes the recovery I3 of an identifier Id_U1 of the first user U1 in a memory of the communications device used by the first user U1 to request the creation of the link, in particular the SIM card of the mobile telephone of the first user. In one particular embodiment, the identifier Id_U1 of the first user is a certified identifier.

In one particular embodiment, the first user uses interface means (I1, I2, I3) to request the creation of the link.

In one particular embodiment the invitation inv U1→U2 is transmitted T1 to a telecommunications network which verifies whether it is possible to set up a link with the second user, notably as a function of the identifier; if not N a message mssg indicating no creation of a link is sent C3 to the first user U1.

In one particular embodiment, the invitation inv U1→U2 is transmitted T2 via a telecommunications network to a communications device of the second user U2, in particular the communications device associated with the identifier Id_U2 or the certified identifier. In particular, this transmission T2 is effected if the second user U2 has a certified identifier IdC_U2 as verified T1 by the network.

In one particular embodiment, the telecommunications link is valid if the holder and the visitor are agreed: in particular, the second user U2 is offered A1 the setting up of a link with the first user U1. The second user U2 responds R_U2 to this offer. The second user U2 accepts Acc_U2 or refuses N the setting up of this link. If they refuse N, a message mssg indicating no creation of a link is sent C3 to the first user U1.

In one particular embodiment, before the creation of the link, it is verified C1 whether the two identifiers Id_U1 and Id_U2 provided are certified and/or recovered from the certified identifiers IdC_U1 and IdC_U2 associated with the identifiers Id_U1 and Id_U2 provided. If at least one of the two users has no certified identifier, the link is not created N and a message mssg indicating no creation of a link is sent C3 to the first user U1.

In one particular embodiment, the certified identifiers IdC_U1, IdC_U2 are supplied by the SIM cards of the communications devices associated with the first user U1 and the second user U2, respectively. The SIM card provides strong authentication. This certification makes it possible on generating a telecommunications link to assign responsibility to both users, the first user U1 and the second user U2, as they are identified unambiguously. Furthermore, certifying the link makes it possible to establish mutual trust between the two users of the link. The responsibility and the mutual trust established for this link in this way then make it possible to use the link for applications for which they are indispensable, such as content sharing.

In one particular embodiment, the link created is stored.

In one particular embodiment, the telecommunications link creation method includes sending an invitation inv U1→U2 from a communications device of the first set having a certified identifier of the first user to a communications device of the second set having a certified identifier of the second user. The first user is also referred to as the inviting or host or source user. The link may be a tool that does not function on a one-to-one basis because the host user may be determined as being solely responsible for the link, i.e. in particular assigned administrator functions in respect of applications opened using this link. In the context of using the link for content sharing, for example, only the host user is able to manage access rights to contents that only they may make available. They are therefore responsible for what they offer and the use that is made thereof by the second user of the link, also called the guest or destination user.

In one particular embodiment, these links may be managed in a dedicated address book of the link or in an address book specific to a mode of communication, for example a mobile telephone address book, an electronic mail address book or a convergent address book. Using a convergent address book has the benefit of making it possible to manage sets of communications devices associated with users and thus to manage convergence of terminals.

In particular, for each second user entered in the address book of a first user, in addition to the communications device identifiers such as the email address, landline telephone number and/or mobile telephone number, there is stored one or more link identifiers and possibly their attributes, such as whether the link is a time-limited link (indicating the time period of the link may be envisaged where appropriate), the status of a link (host, guest, refused by the guest, no link, activation request), the actions possible on the link (cancellation, new request, activation, invitation to process), and where appropriate the communications device from the set of communications devices of the user that is to be used for this link.

Having a plurality of links stored for one and the same second user may be envisaged:
a link of which the first user is the host and the second user is the guest; and
a link of which the first user is the guest and the second user is the host (this configuration is of particular benefit if the links are not one-to-one links, i.e. if the host user has some means and/or functions that the guest user does not have such as administrator and/or moderator functions, networked storage means, etc.); or
an unlimited link between a first user and a second user for an application (for example reading a content); and
a limited link between the same first and second users for another application (for example contribution to the same content or access to another content).

As an alternative to this last embodiment, a single “one-to-one” link between a first user and a second user may be envisaged for one or more contents (in the broad sense, i.e. multimedia content and/or applications) and one or more access types (read, contribute, etc.).

For example, the status of a link of the first user from the address book may be one or more of the following states:

Hi: unlimited telecommunications link of which the first user is the host;
Ii: unlimited telecommunications link of which the first user is the guest;
He: time-limited or evening link for which the first user is the host;
Ie: time-limited or evening link for which the first user is the guest;
R: telecommunications link request refused by guest second user; and
?: status of activation request (TO BE PROCESSED if the first user is a guest, being processed if the first user is the host)

The actions possible on a link include:

| | |
|---|---|
| CANCELLATION | No particular screen. |
| | Transfer of the request to |
| | the BIND Application Server, |
| | which updates the database, |
| | followed by refreshing of |
| | the page to indicate the new |
| | status |
| ACTIVATION | This action makes it |
| | possible to trigger the |
| | creation of a new link with |
| | the second user |
| NEW REQUEST | This action makes it |
| | possible either to trigger |
| | the creation of a new link |
| | with the second user or to |
| | request the second user to |
| | confirm their refusal of the |
| | link |
| INVITATION TO PROCESS | This action makes it |
| | possible to authorize the |
| | creation of a new link the |
| | first user of which is a |
| | guest |
| TRANSFER | This action allows to |
| | transfer the use of the link |
| | from the first user to a |
| | third user in a global way |
| | for all the applications to |
| | share associated with the |
| | link, or for one or several |
| | applications in particular |
| | selected among all the |
| | applications to share |
| | associated with the link. |

In one particular embodiment, the link is associated with a time period in order to limit the duration of use of the link; this is a link meeting type link.

In one particular embodiment, a group meeting link includes a plurality of second users and a time period. Group meeting link creation includes creating telecommunications links between the source user and each destination user, each time including generation C2 of a pair of certified identifiers (IdC_U1 and IdC_U2) of the first and second users allowing a multi-user communications session to be set up between at least a communications device from the first set and a communications device from each of the second sets.

In one particular embodiment, because they are identified unambiguously, the telecommunications link allows billing to be calculated for the host user and/or the guest user.

In one particular embodiment, this method takes the form of a program comprising program code instructions for executing the steps of the telecommunications link creation method when said program is executed by a processor.

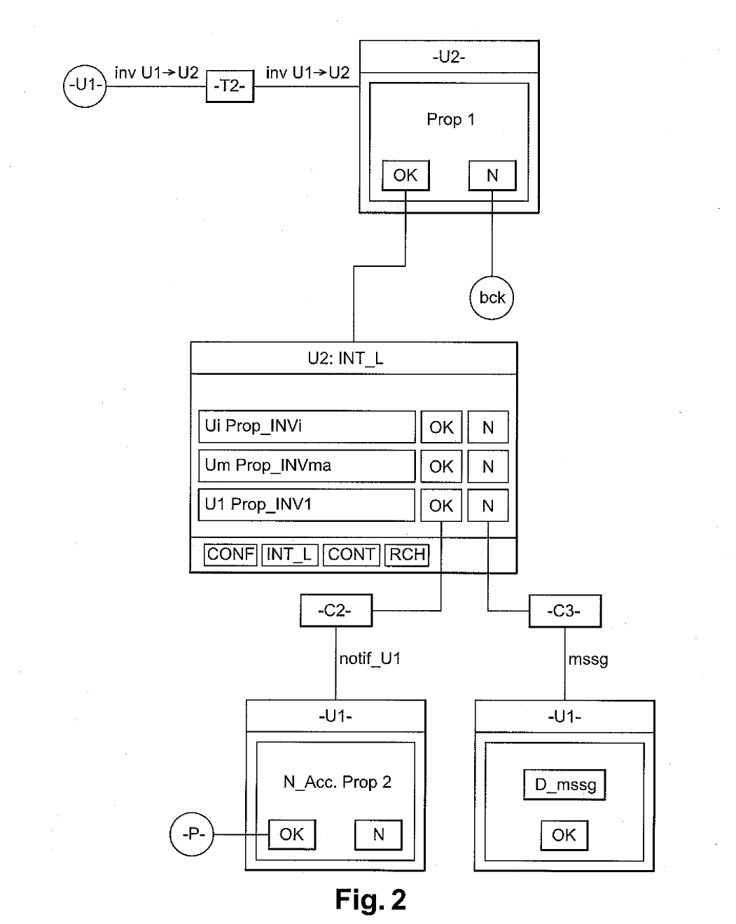

FIG. 2 is a detailed diagram of a telecommunications link creation method of a different embodiment of the invention.

The host user, here the first user U1, requests activation, i.e. creation, of a link with a second user U2 in the form of an invitation inv U1→U2. For example, this request is processed T2 by a network device that stores the link request and notifies the second user of the invitation inv U1→U2.

The user U2 reads the link request notification from the user U1 and the immediate processing proposal P1 and either accepts OK or refuses N this proposal. If the user refuses, the link proposal interface is automatically closed BCK.

If the user U2 accepts, a link management interface U2: INT_LC is opened that lists all link requests to be processed; in the figure there are three requests from the users Ui, Um, and U1 for which the user U2 may independently accept OK or refuse N creation of the link.

If the user U2 refuses the request, a message mssg is sent C3 to the host user U1, Um or U1, who may then read the refusal message D_mssg and indicate OK they have read it.

If the user U2 accepts the request, the associated link is created C2 and the host Ui, Um or U1 is notified and may then read the link creation message and see the proposal to associate an application therewith, for example a content P to be shared.

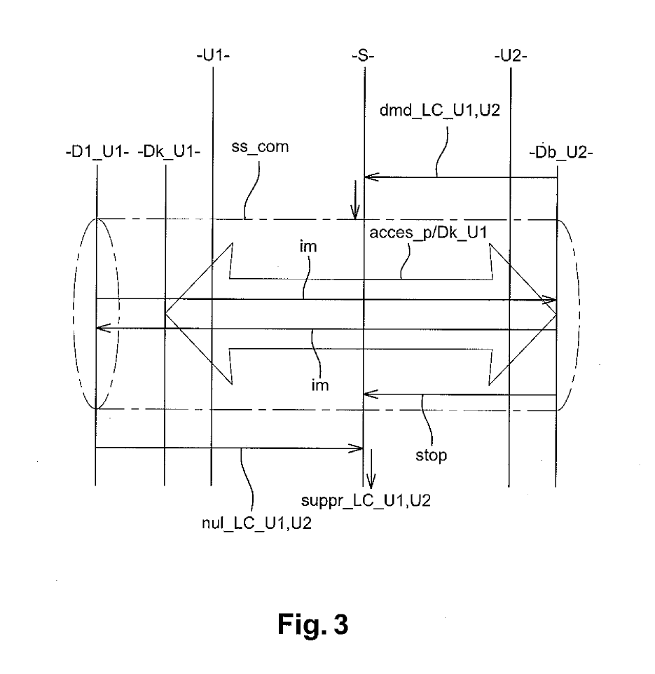

FIG. 3 shows a simplified diagram of telecommunications link use in accordance with the invention. Telecommunications link use includes setting up from a pair of certified identifiers (IdC_U1, IdC_U2) of first and second users a telecommunications link LC_U1, U2 and a communications session ss_com between at least a communications device D1_UI of a first set of communications devices {D1_U1, . . . , Dk_U1} associated with said first user U1 and a communications device Db_U2 of a second set of communications devices {D1_U2, . . . , Db_U2} associated with said second user U2.

In particular, this link use method includes verification that the communications device D1_U1 initiating use of the link LC_U1, U2 is indeed a communications device of the first set of communications devices associated with the first user U1 of said link, in particular before using said link to set up the communications session ss_com.

In particular, the link use method includes verification that the communications device Db_U2 of the other party using the link LC_U1, U2 is indeed a communications device of the second set of communications devices associated with the second user U2 of said link, in particular before using said link to set up the communications session ss_com.

These communications device verifications are in particular authentications. These verifications are in particular either effected by a telecommunications network device that includes link creation means that were used to create said link between the first user and the second user or triggered by this network device for use by authentication means in the communications network.

In one particular embodiment, the session ss_com makes it possible for the second user to access acces_p/Dk_U1 one or more contents made available by the first user U1 on a communications device Dk_U1 consisting either of a terminal of the first user as shown in FIG. 3 or a server S in the telecommunications network, for example a server of a service provider managing the links.

In one particular embodiment, the session ss_com makes it possible for the first user U1 and the second user U2 to communicate synchronously, for example by instant messaging im, or even by VoIP, simultaneously or not with accessing the content.

In particular, the first user U1 may transfer the control of an application to be shared P to a third user U3 (not illustrated). This transfer allows to transfer from the first user U1 to the third user U3 the sharing of the application to be shared P, i.e. the session ss_com allowing the third user U3 and the user second U2 to exchange in a synchronous way im for example by immediate messaging, even by VOIP, simultaneously or not in the access to the contents.

For example, a nurse managing a surveillance duty of remote patient including a medical data measurement application may transfer the control of this medical data measurement application for certain patients to a trainee. Thus, when the patient will access the application for example to transmit his blood pressure, the trainee can get in touch with the patient and help him in the use of this measurement application. The trainee might access too, with the same rights as the nurse, to the medical data measurement application such as accessed by the patient, i.e. in the same context as the patient. Thus the trainee will see at once at which stage of the measurement application the patient needs help, and may better help him via the established communication. Besides, the trainee might interact too with the measurement application to help the patient.

In one particular embodiment, the session ss_com consists of as many communications sessions as there are communications modes, for example a content streaming communications session for accessing the content, a VoIP voice communications session, a text or data communications session for instant messaging.

In one particular embodiment, either the first or second user (the second user U2 in the FIG. 3 example) closes the communications session stop. In one variant of the invention, stopping use of the application offered by the link (in particular end of access to the shared content) by the second user U2 closes the session.

In one particular embodiment, the method includes the on-demand suppression suppr_LC_U1, U2 of a telecommunications link between first and second users nu1_LC_U1, U2 at the request of at least a communications device D1_U1 of a first set of communications devices associated with a first user U1 and a second set of communications devices associated with a second user U2.

The link may be suppressed by either the first user or the second user, i.e. by either of the host and guest users.

In one particular embodiment, the link use method is implemented in the form of a program comprising program code instructions for executing steps of the method of using a telecommunications link when said program is executed by a processor. This processor is integrated into a service management device and/or a communications device of the first user.

The embodiments described above may be implemented individually or in combination.

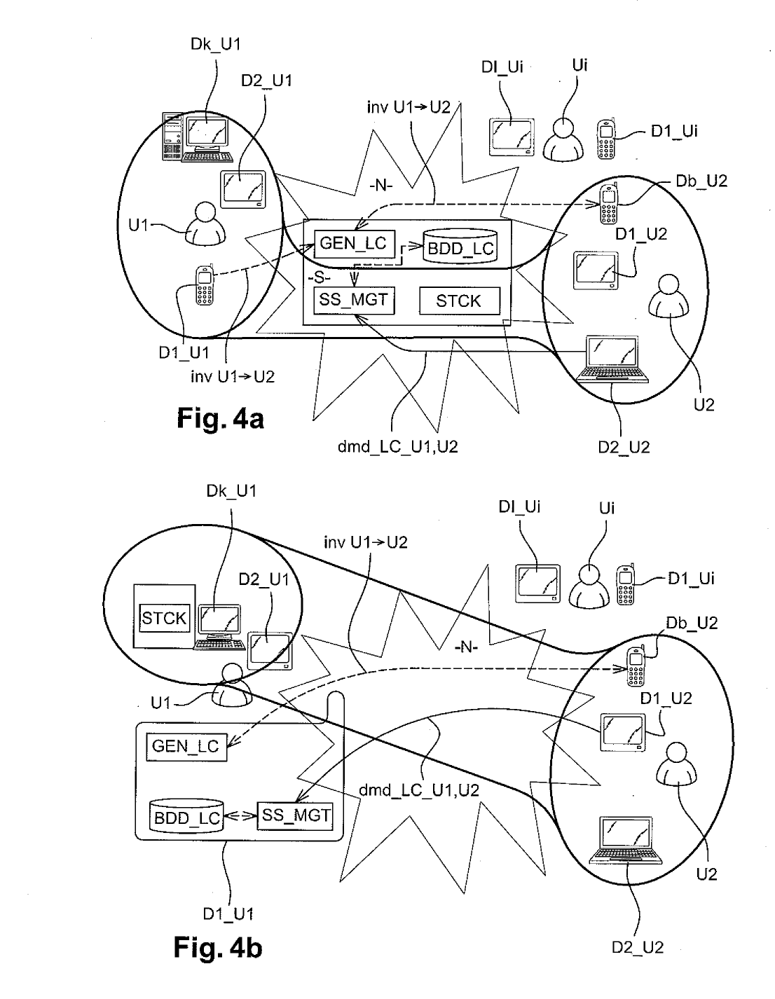

FIGS. 4a and 4b are simplified diagrams of telecommunications network architectures providing for creating and using a telecommunications link in accordance with the invention in a service management device and in a communications device of a first user, respectively.

One or more telecommunications networks N (in particular ADSL, XDSL, etc. cable telecommunications networks, cellular, notably 3G, UMTS, etc. cellular telecommunications networks, optical networks, etc.) service a plurality of users U1, U2, . . . , Ui for exchanging and receiving data or contents in various formats: voice communication, video, synchronous and asynchronous messaging, multimedia contents, applications, etc.

To this end, the users have access to sets of communications devices such as computers Dk_U1, D2_U2, mobile telephones D1_U1, Db_U2, D1_Ui, televisions connected or not via set-top boxes D2_U1, D1_U2, DI_Ui.

In the FIG. 4a example, a server S constitutes a relational service management device. It includes a device of the telecommunications network. It also includes means GEN_LC for generating a pair of certified identifiers of a first user U1 and a second user U2 allowing a communications session to be set up between at least a communications device of a first set of communications devices {D1_U1, D2_U1, . . . , Dk_U1} associated with said first user and a communications device of a second set of communications devices {D1_U2, D2_U2, . . . , Db_U2} associated with said second user.

In one particular embodiment, a link inv U1→U2 from a first user (host user) U1 to a second user (guest user) U2 is generated by the on-demand generation means.

In one particular embodiment of the invention, the server S or the service management device of the server S includes a link database BDD_LC for saving all the links. This database BDD_LC may be located at a single point of the telecommunications network N or distributed, in particular to make it possible to reduce the time needed for each user U1, U2, Ui to access links of which it is the host or even links of which it is a guest.

In one particular embodiment of the invention, the server S or a service management device of the server S includes communications session set-up means SS_MGT allowing a communications session to be set up using a link, in particular an on-demand link dmd_LC_U1, U2, of a user U2 of a link.

In one particular embodiment of the invention, the server S or a service management device of the server S includes means STCK for storing contents p associated with a first user U1 of said telecommunications link C_U1, U2 allowing a communications device Db_U2 of the second user U2 to access said content associated with said first user of said telecommunications link during a telecommunications session ss_com set up using said link.

The embodiments described above with reference to FIG. 4a may be implemented individually or in combination.

In an embodiment shown in FIG. 4b that is an alternative to that shown in FIG. 4v, the means GEN_LC for generating a pair of certified identifiers of a first user U1 and a second user U2 allowing a communications session to be set up between at least a communications device of a first set of communications devices associated with said first user {D1_U1, Dk_U1} and a communications device of a second set of communications devices associated with said second user {D1_U2, D2_U2, . . . , Db_U2} are implemented in a distributed manner in one of the communications devices of each user. Thus when a first user U1 wishes to create a link, these means are the generation means GEN_LC available in one of these communications devices D1_U1 or a communications terminal such as the mobile telephone shown in FIG. 4b, in particular a terminal having access to the certified identifier of the first user IdC_U1, or a communications device in the communications network and associated with the first user (not shown).

In one particular embodiment, an on-demand link inv U1→U2 from a first user (host user) U1 to a second user (guest user) U2 is generated by the generation means.

In one particular embodiment of the invention, the communications device of the first user D1_U1 includes a links database BDD_LC for storing all the links.

In one particular embodiment of the invention, the communications device of the first user D1_U1 includes communications session set-up means SS_MGT allowing a communications session to be set up using a link, in particular an on-demand link dmd_LC_U1, U2 of a user U2 of a link.

In one particular embodiment of the invention, a communications device of the first user, which is either distinct from (as shown: Dk_U1) or not distinct from the communications device D1_U1 including the link generation means GEN_LC, includes means STCK for storing contents p associated with a first user U1 of said telecommunications link C_U1, U2 allowing a communications device Db_U2 of the second user U2 to access said content associated with said first user of said telecommunications link during a telecommunications session ss_com set up using said link.

The embodiments described above with reference to FIG. 4b may be implemented individually or in combination.

In one particular embodiment, access and terminal convergence make it possible for the host and the guest to communicate at the same time as viewing the content, use of the content remaining under the control of the guest.

In a particular embodiment shown in FIGS. 4a and 4b, if it was a user U2 who requested the setting up of the link dmd_LC_U1, U2, that link was set up between at least one communications device of the first set of communications devices of the first user U1 and at least one communications device of the second set of communications devices of the second user U2, for example between at one end of the link: a communications device D2_U1, a communications device associated with the first user U1 in the telecommunications network N (not shown), and at the other end of the link: a communications device D1_U2.

In particular, either or both of the first and second users may indicate during creation of the link the communications devices in their set of communications devices to be used when using the link. Thus, during use of the link, the session is set up with the indicated communications devices associated with the link.

Either or both of the first and second users may indicate rules for use of the communications devices of the set of communications devices as a function of one or more parameters associated with a communications session. Accordingly, during use of the link, the session is set up with the communications devices determined as a function of these rules of use. These rules make it possible in particular to optimize the use of the installed base of communications devices as a function of the capabilities of the terminals in relation to the data transmitted during the communications session (use of an HD television to display HD video plus a computer for collaboration on a presentation, etc.) and/or access of the user to these communications devices during the communications session (use of the mobile telephone while traveling, use of the computer at the office, etc.). Access to a communications device may be detected using a presence management system and/or a diary, etc.

The invention makes possible in particular authentication of a person (first or second user) via their communications devices (terminals), association of the link with billing the first user (initiator of the creation of the link), and in particular construction by the first user of the potential for sharing contents (for example applications) that they choose and over which they retain control. This invention makes use of a link platform possibly associated with a content access rights platform (security, tattooing).

### INDUSTRIAL APPLICATION

The field of application of the invention is very wide as it covers all remote uses that have become possible by means of technological advances in the context of strong relations between a person and other persons or between a person and a professional or a company. These advances are particularly beneficial in the development of telecommunications applications, content management (in particular sharing) applications, and communicating object management applications.

Moreover, the link of the invention makes it possible to set up communications sessions between telecommunications devices regardless of the carrier.

What is claimed is:

1. A method of creating a telecommunications link between a first set of communications devices associated with a first user and a second set of communications devices associated with a second user, including generating a pair of certified identifiers of the first and second users allowing a communications session to be set up between at least a communications device of the first set and a communications device of the second set.

2. The telecommunications link creation method according to claim 1, wherein said telecommunications link creation method includes an invitation from a communications device of the first set having access to a certified identifier of the first user to a communications device of the second set having access to a certified identifier of the second user.

3. A program comprising program code instructions for executing the steps of the telecommunications link creation method according to claim 1 when said program is executed by a processor.

4. A method of using a telecommunications link including setting up, from a pair of certified identifiers of a first user and a second user of a telecommunications link, a communications session between at least a communications device of a first set of communications devices associated with said first user and a communications device of a second set of communications devices associated with said second user.

5. The telecommunications link use method according to claim 4, wherein said method includes a transfer from the user first one to a third user, said transfer allowing to transfer said communications session from a communication device of first set of communication devices associated with first user to at least a communication device of a third set of communication devices associated with third user.

6. The telecommunications link use method according to claim 4, wherein said method includes an association of an application to be shared with said link of telecommunication.

7. The telecommunications link use method according to claim 4, wherein said method includes a transfer from the first user to the third user, said transfer allowing transferring from the first user to the third user a sharing of an application to share associated said link of the first user with the second user.

8. The telecommunications link use method according to claim 4, wherein said method includes an on-demand suppression of a telecommunications link between a first user and a second user at the request of at least one communications device of a first set of communications devices associated with the first user and a second set of communications devices associated with a second user.

9. A program comprising program code instructions for executing the steps of the method of claim 4 for using a telecommunications link when said program is executed by a processor.

10. A telecommunications link including a pair of certified identifiers of a first user and a second user allowing a communications session to be set up between at least a communications device of a first set of communications devices associated with the first user and a communications device of a second set of communications devices associated with the second user.

11. A telecommunications network device including means for generating a pair of certified identifiers of a first user and second user allowing a communications session to be set up between at least a communications device of a first set of communications devices associated with said first user and a communications device of a second set of communications devices associated with said second user.

12. A telecommunications network device according to claim 11, wherein said telecommunications network device includes means for setting up, from a pair of certified identifiers of a first user and a second user, a communications session between said communications device of said first user and a communications device of said second set.

13. A device for managing a relational service between users including a telecommunications network device according to claim 11.

14. The service management device according to claim 13 including means for storing contents associated with a first user of said telecommunications link allowing a communications device of the second user to access said content associated with said first user of said telecommunications link during a telecommunications session set up using said link.

15. A communications device of a first user including a telecommunications network device according to claim 11, wherein the certified identifier of the first user is provided by said communications device.
